(19) United States
(12) Patent Application Publication
(10) Pub. No.: US 2024/0103533 A1
(43) Pub. Date: Mar. 28, 2024

(54) AIRCRAFT CONTROL SYSTEM, METHOD OF CONTROLLING AIRCRAFT, AIRCRAFT CONTROL PROGRAM, AND AIRCRAFT

(71) Applicant: SUBARU CORPORATION, Tokyo (JP)

(72) Inventors: Yasunori SHIBAO, Tokyo (JP); Takumi OHKI, Tokyo (JP)

(21) Appl. No.: 18/460,818

(22) Filed: Sep. 5, 2023

(30) Foreign Application Priority Data
Sep. 23, 2022 (JP) 2022-152020

(51) Int. Cl. G05D 1/10; G05D 1/00; G06N 3/092

(52) U.S. Cl. CPC G05D 1/101; G05D 1/0088; G06N 3/092

(57) ABSTRACT

An aircraft control system includes a rule setting part, a reinforcement learning part, an evaluation part and a pilot information generation part. The rule setting part sets a rule. First decision making is performed prior to second decision making. The rule is used for the second decision making based on an initial result of the first decision making. The reinforcement learning part acquires learning results, used for the decision making, by reinforcement learning. The evaluation part evaluates results of the decision making. The pilot information generation part generates information for supporting pilot of an aircraft. The evaluation part settles the first learning result based on the rule when second learning result has not been acquired, and settle the first learning result based on the second learning result when the second learning result has been acquired.

### CROSS REFERENCES TO RELATED APPLICATIONS

This application is based upon and claims the benefit of priority from Japanese Patent Application No. 2022-152020, filed on Sep. 23, 2022; the entire contents of which are incorporated herein by reference.

### FIELD

Implementations described herein relate generally to an aircraft control system, a method of controlling an aircraft, an aircraft control program, and an aircraft.

### BACKGROUND

In recent years, AI (Artificial Intelligence) performing reinforcement learning is utilized in various technical fields (for example, refer to Japanese Patent Application Publication JP H11-015807A and Japanese Patent Application Publication JP H11-306216A). Reinforcement learning is a kind of machine learning that a computer mounted with AI repeats trial and error for itself to perform optimal control. Reinforcement learning is also applied to a control system which performs automatic driving of an autonomous car or automatic pilot of a UAV (Unmanned Aerial Vehicle) (for example, refer to Japanese Patent Application Publication JP 2019-105891A).

When an aircraft, such as a UAV, is tried to be automatically piloted using a control system mounted with AI, the control system must perform complicated behavioral judgments. That is, the control system is sometimes required to perform two or more judgments for completing an overall behavioral judgment. As a concrete example, when a task that a certain mission is accomplished is given to a UAV, AI cannot determine a flight path unless the AI has determined a destination, and the AI cannot determine control quantities of the airframe, such as a rotating speed of a rotary wing, unless the AI has determined the destination.

Accordingly, when a UAV or the like is tried to be automatically piloted by AI, an attempt that the AI is made to learn by curriculum reinforcement learning, in which an overall behavioral judgment is divided into two or more partial behavioral judgments so that the learning can be performed in steps, is considered.

However, when AI performs curriculum reinforcement learning, a learning result becomes partial since the learning is performed for each partial behavioral judgment during the learning. Accordingly, the total evaluation cannot be performed unless all the learning is completed. As a result, after downstream learning was progressed, it may become necessary to return to upstream learning again and restart the upstream learning. That is, in case of curriculum reinforcement learning, reworking may become swell. As a concrete example, when a control quantity of the airframe of a UAV, such as a rotating speed of a rotary wing, fell within an unrealizable condition after AI has determined a flight path of the UAV to a destination, behavioral judgment must be performed from the determination of a destination again.

In addition, in case of curriculum reinforcement learning by AI, there is concern that the development scale of the AI becomes large since it is necessary to give one or more conditions according to a stage of learning as well as to create attainment criteria.

Accordingly, an object of the present invention is to allow AI to perform reinforcement learning of matters required for decision making in a shorter time in case of supporting pilot of an aircraft, such as a UAV, using a control system mounted with the AI.

### SUMMARY OF THE INVENTION

In general, according to one implementation, an aircraft control system includes a rule setting part, a reinforcement learning part, an evaluation part and a pilot information generation part. The rule setting part is configured to set a rule. First decision making is performed prior to second decision making. The first decision making and the second decision making are performed for flying an aircraft. The rule is used for performing the second decision making based on an initial result of the first decision making. The reinforcement learning part is configured to acquire a first learning result and a second learning result. The first learning result is acquired by first reinforcement learning targeting a first learning case. The second learning result is acquired by second reinforcement learning targeting a second learning case different from the first learning case. The first learning result is used for the first decision making. The second learning result is used for the second decision making. The evaluation part is configured to evaluate results of the first decision making and results of the second decision making. The pilot information generation part is configured to generate information for supporting pilot of the aircraft, based on the first learning result and the second learning result. The evaluation part is configured to: settle the first learning result by evaluating the initial result of the first decision making through the first reinforcement learning and a result of the second decision making based on the rule when the second learning result has not been acquired prior to the first reinforcement learning; and settle the first learning result by evaluating another result of the first decision making through the first reinforcement learning and another result of the second decision making based on the second learning result when the second learning result has been acquired prior to the first reinforcement learning.

Further, according to one implementation, an aircraft includes the above-mentioned aircraft control system.

Further, according to one implementation, a method of controlling an aircraft includes: setting a rule; acquiring a first learning result and a second learning result; evaluating results of first decision making and results of second decision making; and generating information for supporting pilot of the aircraft, based on the first learning result and the second learning result. The first decision making is performed prior to the second decision making. The first decision making and the second decision making are performed for flying the aircraft. The rule is used for performing the second decision making based on an initial result of the first decision making. The first learning result is acquired by first reinforcement learning targeting a first learning case. The second learning result is acquired by second reinforcement learning targeting a second learning case different from the first learning case. The first learning result is used for the first decision making. The second learning result is used for the second decision making. When the second learning result has not been acquired prior to the first reinforcement learning, the first learning result is settled by evaluating the initial result of the first decision making through the first reinforcement learning and a result of the second decision making based on the rule. When the second learning result has been acquired prior to the first reinforcement learning, the first learning result is settled by evaluating another result of the first decision making through the first reinforcement learning and another result of the second decision making based on the second learning result.

Further, according to one implementation, an aircraft control program makes a computer execute: setting a rule; acquiring a first learning result and a second learning result; evaluating results of first decision making and results of second decision making; and generating information for supporting pilot of the aircraft, based on the first learning result and the second learning result. The first decision making is performed prior to the second decision making. The first decision making and the second decision making are performed for flying an aircraft. The rule is used for performing the second decision making based on an initial result of the first decision making. The first learning result is acquired by first reinforcement learning targeting a first learning case. The second learning result is acquired by second reinforcement learning targeting a second learning case different from the first learning case. The first learning result is used for the first decision making. The second learning result is used for the second decision making. When the second learning result has not been acquired prior to the first reinforcement learning, the first learning result is settled by evaluating the initial result of the first decision making through the first reinforcement learning and a result of the second decision making based on the rule. When the second learning result has been acquired prior to the first reinforcement learning, the first learning result is settled by evaluating another result of the first decision making through the first reinforcement learning and another result of the second decision making based on the second learning result.

### BRIEF DESCRIPTION OF THE DRAWINGS

In the accompanying drawings:

FIG. 1 is a configuration diagram of an aircraft mounted with an aircraft control system according to an implementation of the present invention;

FIG. 2 is a perspective view showing an example of appearance of the aircraft shown in FIG. 1;

FIG. 3 is a functional block diagram showing an example of detailed configuration of the aircraft control system shown in FIG. 1;

FIG. 4 is a chart for explaining a method of the reinforcement learning of the AI in the aircraft control system shown in FIG. 3;

FIG. 5 is a flow chart showing an example of flow in case of controlling the aircraft by the aircraft control system shown in FIG. 3;

FIG. 6 shows input information into the AI and output information from the AI for controlling the aircraft shown in FIG. 5;

FIG. 7 is a diagram for explaining the learning method of the AI at the time of starting the reinforcement learning shown in FIG. 6; and

FIG. 8 is a diagram for explaining an example of reinforcement learning of the AI performed subsequently to the reinforcement learning shown in FIG. 7.

### DETAILED DESCRIPTION

An aircraft control system, a method of controlling an aircraft, an aircraft control program, and an aircraft according to implementations of the present invention will be described with reference to accompanying drawings.

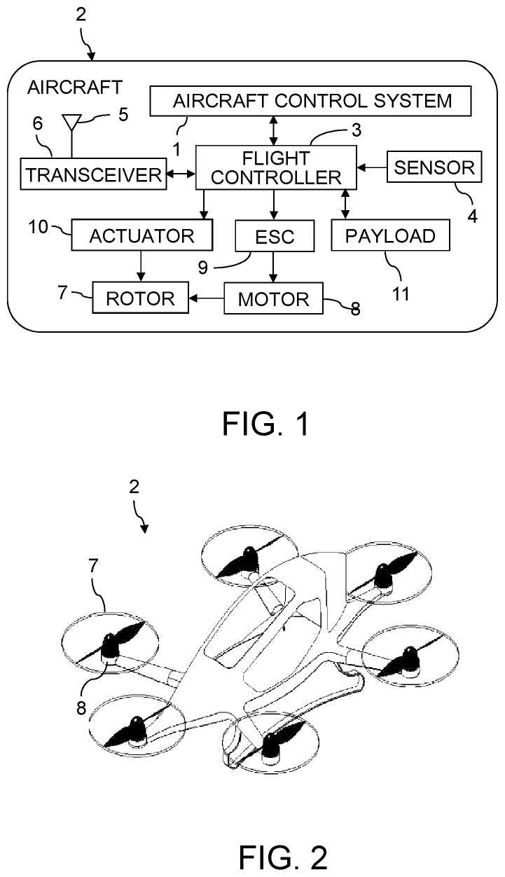

FIG. 1 is a configuration diagram of an aircraft mounted with an aircraft control system according to an implementation of the present invention. FIG. 2 is a perspective view showing an example of appearance of the aircraft shown in FIG. 1.

An aircraft control system 1 generates information, such as an automatic pilot program of the aircraft 2, for supporting pilot of the aircraft 2 by making AI to perform reinforcement learning using flight cases of the aircraft 2 as learning cases. Accordingly, the aircraft control system 1 can be mounted on the aircraft 2.

The aircraft 2 typically has a flight controller 3 for controlling the airframe of the aircraft 2. Therefore, information, such as an automatic pilot program, generated by the aircraft control system 1 can be output to the flight controller 3. Accordingly, the aircraft control system 1 may be built in the flight controller 3.

Representative examples of the aircraft 2 on which the aircraft control system 1 is mounted include not only a UAV, on which people does not board, but a manned aircraft, on which people board, and an OPV (Optionally Piloted Vehicle). An OPV is an unmanned aircraft on which a pilot can board to pilot the aircraft, i.e., a hybrid aircraft of a manned aircraft and an unmanned aircraft. A small UAV, which is also called a drone in a broad sense, is typified by unmanned multicopter and helicopter. The aircraft 2 may be not only a rotorcraft, such as a multicopter or a helicopter, but a fixed-wing aircraft.

When the aircraft 2 is a UAV or an OPV, sensors 4 for measuring the position, altitude, attitude and the like of the aircraft 2 as well as a transceiver 6, having an antenna 5, for remote control of the aircraft 2 are coupled to the flight controller 3 as exemplified by FIG. 1. In case of a rotorcraft, such as a multicopter or a helicopter, the aircraft 2 has rotors 7, motors 8, an ESC (Electric Speed Controller) 9 and actuators 10 as exemplified by FIG. 1. The rotors 7 are rotated by the motors 8 respectively. The ESC 9 controls the rotating speeds of the motors 8. The actuators 10 adjust the pitch angles of the rotors 7 respectively. The ESC 9 and the actuators 10 are controlled by control signals output from the flight controller 3.

Note that, a small multicopter, such as a quadcopter or a hexacopter, often has the rotors 7 whose pitch angles are not adjustable. A small multicopter having the rotors 7 whose pitch angles are fixed is called a drone in a narrow sense. In that case, the actuators 10 are omitted while ups and downs of the aircraft 2 are performed only by controlling the rotating speeds of the rotors 7. Note that, a small multicopter is called a drone in a broad sense even when the multicopter has the rotors 7 whose pitch angles are variable.

When the aircraft 2 is a UAV or an OPV, the aircraft 2 can be remote-controlled with wireless communications. Accordingly, the aircraft control system 1 may not be mounted on the aircraft 2, but may be placed on the ground or built in a portable controller. In this case, control information of the aircraft 2, such as an automatic pilot program of the aircraft 2, can be transmitted to the aircraft 2 through wireless communications.

When the aircraft control system 1 is not mounted on the aircraft 2, the reinforcement learning of the AI can be performed by simulation of flights of the aircraft 2. Alternatively, the reinforcement learning of the AI may be performed using actual flight cases of the aircraft 2 as learning cases by utilizing wireless communications with the aircraft 2. Conversely, when the aircraft control system 1 is mounted on the aircraft 2 as exemplified by FIG. 1, the reinforcement learning of the AI can be performed not only by simulation but using actual flight cases of the aircraft 2 as learning cases without wireless communications. Note that, when the reinforcement learning of the AI is performed by simulation, a simulator can be coupled to an I/O (Input/Output) interface of the aircraft control system 1 so that necessary information can be input and output to and from the aircraft control system 1.

Information generated by the AI of the aircraft control system 1 may include desired information for supporting pilot of the aircraft 2. As a concrete example, at least one of a target point or object of the aircraft 2, a flight path of the aircraft 2, and control quantity or control quantities of the airframe of the aircraft 2, which is not designated by a user, can be automatically determined in the aircraft control system 1. Note that, a target object of the aircraft 2 may not be specified as a positional coordinate, but may be an object or a moving body, in a designated airspace, to be discovered by observation like a cumulonimbus cloud or another aircraft.

In addition, information for operating at least one payload 11 mounted on the aircraft 2 may also be generated in the aircraft control system 1. Concrete examples of the payload 11 include a radar, a camera, a light device, a speaker, a microphone, a spraying device of agricultural chemical or the like, and a drive arm allowing discharge or the like.

The more matters which the aircraft control system 1 should determine, out of the whole matters which must be determined in order to fly the aircraft 2, are increased by decreasing matters which a user should designate, the more matters which the AI should judge become complicated. Allowing the AI to perform judgments requires precedent reinforcement learning of the AI. Therefore, when the matters which the AI should judge become complicated, contents of the reinforcement learning also become complicated.

As a concrete example, when a user designates a destination and a flight path of the aircraft 2 while the aircraft control system 1 determines only control quantities of the airframe of the aircraft 2 for making the attitude of the airframe appropriate, matters which the AI judges as well as contents of reinforcement learning for the judgments are simple. On the other hand, when a user designates a destination of the aircraft 2 while the aircraft control system 1 determines a flight path of the aircraft 2 and control quantities of the airframe according to the flight path, matters which the AI judges as well as contents of reinforcement learning for the judgments are complicated. Further, when a user designates only a mission of the aircraft 2 while the aircraft control system 1 determines matters including a destination of the aircraft 2, matters which the AI judges as well as contents of reinforcement learning for the judgments are more complicated.

That is, the more matters which a user designates are detailed, the simpler matters which the aircraft control system 1 judges and determines become. Conversely, the more matters which a user designates are general, the more matters which the aircraft control system 1 judges and determines become complicated. In addition, when matters which a user designates are general, the aircraft control system 1 must perform two or more kinds of decision making hierarchically and sequentially.

As a concrete example, when a user specifies only a mission of the aircraft 2, the aircraft control system 1 determines a target point or target object of the aircraft 2, and subsequently, determines a flight path of the aircraft 2 according to the target point or target object of the aircraft 2, and further subsequently, determines control quantities of the airframe of the aircraft 2 according to the flight path of the aircraft 2. That is, matters to be determined include an object of previous decision making and an object of subsequent decision making which cannot be started unless the previous decision making is completed.

Hereinafter, a complicated case will be described mainly on the assumption that a user designates a mission of the aircraft 2 while at least a target point or target object, a flight path and control quantities of the airframe of the aircraft 2 are objects of decision making by the aircraft control system 1. Since pieces of decision making in the aircraft control system 1 are performed by AI, results of the pieces of the decision making are pieces of information output from the AI while information which should be input into the AI is pieces of information necessary for the pieces of the decision making. When pieces of measured data by the sensors 4, such as a position, an altitude and an attitude of the aircraft 2, are pieces of input information into the AI, the pieces of measured data can be input from the sensors 4 into the aircraft control system 1 through the flight controller 3.

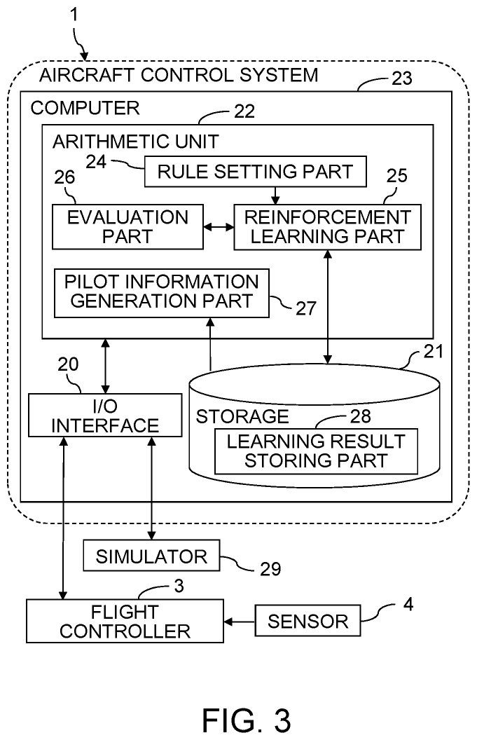

FIG. 3 is a functional block diagram showing an example of detailed configuration of the aircraft control system 1 shown in FIG. 1.

The aircraft control system 1 can be set up by circuitry typified by a computer 23, having an I/O interface 20, storage 21 and an arithmetic unit 22, on which an aircraft system program has been installed. More specifically, the arithmetic unit 22 of the aircraft control system 1 functions as a rule setting part 24, a reinforcement learning part 25, an evaluation part 26 and a pilot information generation part 27 by the aircraft system program. Meanwhile, the storage 21 functions as a learning result storing part 28 by the aircraft system program. Thus, the aircraft control system 1 is equipped with a function as the AI by the rule setting part 24, the reinforcement learning part 25, the evaluation part 26, the pilot information generation part 27, and the learning result storing part 28.

As mentioned above, the aircraft control system 1 performs two or more pieces of decision making hierarchically and sequentially. In other words, pieces of decision making is performed for the whole process consisting to two or more partial processes, and the AI of the aircraft control system 1 performs the whole process in which a low-level partial process to be performed afterward cannot be started unless a high-level partial process to be performed previously is completed.

In order to allow the AI to perform decision making, it is necessary to perform reinforcement learning of the AI in advance. Reinforcement learning is a machine learning method by which the AI is made to learn a decision making method so that evaluation on decision making by the AI may become large. When the AI is made to perform reinforcement learning of a process requiring hierarchical pieces of decision making, it is realistic to perform curriculum reinforcement learning in which reinforcement learning is performed for each matter requiring decision making. Accordingly, the aircraft control system 1 is equipped with a function to perform curriculum reinforcement learning of the AI.

Nevertheless, when curriculum reinforcement learning of the AI under the conventional method is tried to be performed for the complicated whole process in which low-level decision making cannot be performed unless high-level decision making is completed, the high-level decision making must be restarted again after learning on the high-level decision making is completed, in order to perform learning on the low-level decision making. In addition, even when evaluation on the high-level decision making meets a criterion, it may become necessary to restart the high-level decision making or it may become difficult to acquire an overall optimal solution itself as long as there is no solution, which meets a criterion, in the low-level decision making. That is, not only reinforcement learning may require vast amounts of hours, but only a local solution that a solution becomes the optimum only for one of pieces of decision making may be acquired.

Accordingly, the aircraft control system 1 is equipped with a function to perform reinforcement learning of the AI for each partial individual piece of decision making while targeting the whole process including two or more hierarchical pieces of decision making. Specifically, the aircraft control system 1 is equipped with a function to allow a user to designate a decision making method as a rule regarding partial piece of decision making which is not an object of learning.

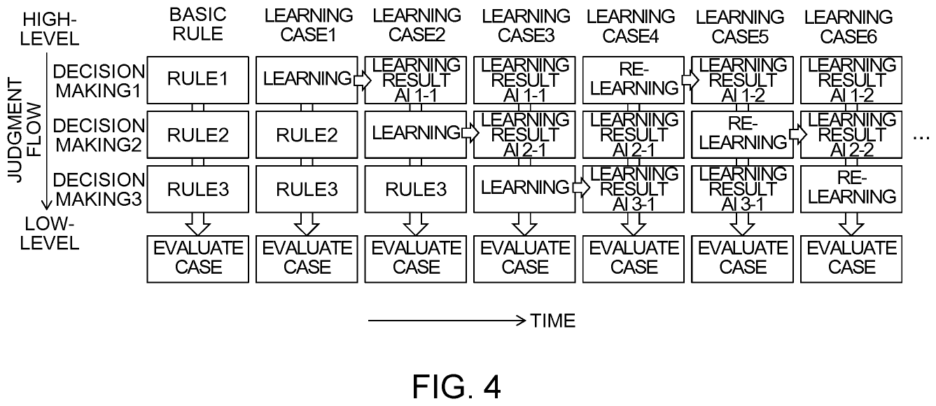

FIG. 4 is a chart for explaining a method of the reinforcement learning of the AI in the aircraft control system 1 shown in FIG. 3.

As mentioned above, in order to fly the aircraft 2, it is necessary to perform two or more pieces of decision making, such as determination of a target point of the aircraft 2 and determination of a flight path of the aircraft 2, hierarchically and sequentially in many cases. That is, it is necessary to perform high-level decision making and low-level decision making, which cannot be started unless the high-level decision making is completed, in order.

FIG. 4 shows a flow of reinforcement learning of the AI in a case where the number of matters for which decision making should be performed is three, i.e. in a case where the AI outputs three kinds of information. More specifically, FIG. 4 shows a reinforcement learning method of the AI in a case where the AI performs the first decision making, the second decision making and the third decision making in order to fly the aircraft 2. The first decision making whose level is the highest is performed first. After the first decision making, the second decision making whose level is lower than that of the first decision making is performed based on a result of the first decision making. After the second decision making, the third decision making whose level is the lowest is performed based on a result of the second decision making. As a matter of course, the fourth decision making and subsequent decision making whose levels are low may be added.

In FIG. 4, the vertical axis direction expresses that the level of decision making is lower at a lower position while the horizontal axis direction expresses time of learning cases, i.e., the identification number direction of the learning cases. At the time of the start of the reinforcement learning before any learning case is given to the AI, any learning result has not yet been acquired. That is, all of the first past learning result for performing the first decision making, the second past learning result for performing the second decision making, and the third past learning result for performing the third decision making do not exist. If the AI is tried to be made to acquire the first to third learning results by reinforcement learning at once in this state, an immense amount of time may be required or a partial solution may be acquired as mentioned above.

Accordingly, in the rule setting part 24 of the aircraft control system 1, a rule for performing low level making decisions based on a result of high level making decisions can be set for each object of decision making in advance of reinforcement learning. Specifically, in case of the example shown in FIG. 4, the first rule for performing the first decision making based on information given from the user, the second rule for performing the second decision making based on a result of the first decision making, and the third rule for performing the third decision making based on a result of the second decision making can be set up as basic rules in advance of reinforcement learning. Information necessary for setting rules can be input from another computer coupled to the I/O interface 20.

As a concrete example, when the first decision making is the determination of a target point or target object of the aircraft 2, information, such as tables or functions, expressing a relation between pieces of information for specifying missions given to the aircraft 2 and coordinates of target points can be set as the first rule. Meanwhile, when the second decision making is the determination of a flight path of the aircraft 2 to the determined target point, one of various rules, such as a rule for setting the shortest path to the target point as the flight path, a rule for setting the path minimizing the fuel consumption as the flight path, or a rule for setting the safest path as the flight path, can be set as the second rule. Moreover, when the third decision making is the determination of control quantities of the airframe of the aircraft 2 flying along the determined flight path, one of various rules, such as a rule for determining the control quantities for arriving at the target point in the shortest time, a rule for determining the control quantities for arriving at the target point with the minimum fuel consumption, or a rule for determining the control quantities for arriving at the target point with the most stable flight, can be set as third rule.

When a rule has been set up for each object of decision making in the rule setting part 24, it becomes possible to perform each stage of the decision making based on a corresponding rule without judgment by the AI. For that purpose, each rule to be set in the rule setting part 24 is set so that required evaluation can be obtained even when all the stages of the decision making are performed based on only the rules. Specifically, in case of the example shown in FIG. 4, the first to third rules are set so that evaluation of a result of the first decision making to the third decision making based on the first to third rules without judgment by the AI may fall within an acceptable range.

When it is made possible to perform each piece of decision making based on a corresponding rule, it becomes possible to perform reinforcement learning of the AI with targeting only a selected piece of the decision making. Reinforcement learning of the AI is performed in the reinforcement learning part 25. Reinforcement learning of the AI is performed for each piece of decision making selected out of pieces of the decision making, based on a different learning case, with changing a selected piece of the decision making.

Specifically, in case of the example shown in FIG. 4, the reinforcement learning part 25 performs the first reinforcement learning for performing the first decision making with targeting the first learning case. Reinforcement learning for performing the second decision making and the third decision making is not performed for the first learning case, but the second decision making and the third decision making are performed based on the second rule and the third rule respectively. That is, the object of the reinforcement learning for the first learning case can be limited to the first decision making by provisionally settling the second decision making and the third decision making based on the rules.

The result of the first decision making to the third decision making, including the result of the first decision making by the AI for the first learning case, is evaluated in the evaluation part 26. The first decision making in the reinforcement learning part 25 is repeated a predetermined number of times so that the evaluation of the result of the first decision making in the evaluation part 26 may fall within an acceptable range and become higher. Thereby, the reinforcement learning part 25 can acquire the first learning result (AI1-1) for performing the first decision making. The acquired first learning result (AI1-1) can be stored in the learning result storing part 28.

Note that, the evaluation criterion in the evaluation part 26 for the result of the first decision making to the third decision making, i.e., the rule for giving reward to the AI can be preliminarily determined by a user freely and input into the evaluation part 26 from another computer coupled to the I/O interface 20. As a concrete example, one of various evaluation methods, such as a rule which gives higher reward to the AI as the flight distance of the aircraft 2 becomes shorter, a rule which gives higher reward to the AI as the fuel consumption of the aircraft 2 decreases more, or a rule which gives higher reward to the AI as the stability of the aircraft 2 is improved more, can be determined and input into the evaluation part 26.

When the first reinforcement learning is completed and thereby the first learning result (AI1-1) is acquired, the reinforcement learning part 25 performs the second reinforcement learning for performing the second decision making with targeting the second learning case other than the first learning case. Reinforcement learning for performing the first decision making and the third decision making is not performed for the second learning case.

Regarding the first decision making, the first learning result (AI1-1) has already been acquired through the past first learning case. It is considered that the first learning result (AI1-1) acquired by the reinforcement learning of the AI is a method of the first decision making more desirable than the first rule provisionally set by a user. Accordingly, the first decision making for the second learning case is performed based on the first learning result (AI1-1) stored in the learning result storing part 28. Meanwhile, the third decision making is performed based on the third rule since any learning result has not yet been acquired. Thereby, the object of the reinforcement learning for the second learning case can be limited to the second decision making.

The result of the first decision making to the third decision making, including the result of the second decision making by the AI for the second learning case, is evaluated in the evaluation part 26. The second decision making in the reinforcement learning part 25 is repeated a predetermined number of times so that the evaluation of the result of the second decision making in the evaluation part 26 may fall within an acceptable range and become higher. Thereby, the reinforcement learning part 25 can acquire the second learning result (AI2-1) for performing the second decision making. The acquired second learning result (AI2-1) can be stored in the learning result storing part 28.

Then, the reinforcement learning part 25 performs the third reinforcement learning for performing the third decision making with targeting the third learning case other than any of the first learning case and the second learning case. Reinforcement learning for performing the first decision making and the second decision making is not performed for the third learning case.

Regarding the first decision making and the second decision making, the first learning result (AI1-1) and the second learning result (AI2-1) have already been acquired through the past first learning case and the past second learning case respectively. It is considered that the first learning result (AI1-1) and the second learning result (AI2-1) each acquired by the reinforcement learning of the AI are methods of the first decision making and the second decision making more desirable than the first rule and the second rule provisionally set by a user respectively. Accordingly, the first decision making and the second decision making for the third learning case are performed based on the first learning result (AI1-1) and the second learning result (AI2-1) stored in the learning result storing part 28 respectively. Thereby, the object of the reinforcement learning for the third learning case can be limited to the third decision making.

The result of the first decision making to the third decision making, including the result of the third decision making by the AI for the third learning case, is evaluated in the evaluation part 26. The third decision making in the reinforcement learning part 25 is repeated a predetermined number of times so that the evaluation of the result of the third decision making in the evaluation part 26 may fall within an acceptable range and become higher. Thereby, the reinforcement learning part 25 can acquire the third learning result (AI3-1) for performing the third decision making. The acquired third learning result (AI3-1) can be stored in the learning result storing part 28.

When all of the first learning result (AI1-1), the second learning result (AI2-1), and the third learning result (AI3-1) have been stored in the learning result storing part 28, the reinforcement learning part 25 becomes possible to repeat the first reinforcement learning to the third reinforcement learning with targeting learning cases different from each other without using the first rule to the third rule respectively.

Specifically, in case of restarting the first reinforcement learning for performing the first decision making with targeting the fourth learning case, the second decision making and the third decision making can be performed based on the second learning result (AI2-1) and the third learning result (AI3-1) respectively without performing reinforcement learning for performing the second decision making and the third decision making. When the first reinforcement learning is repeated, the reinforcement learning part 25 can acquire the first learning result (AI1-2) which has been updated to a more appropriate result.

This is similar also in case of restarting the second reinforcement learning for performing the second decision making with targeting the fifth learning case, and in case of restarting the third reinforcement learning for performing the third decision making with targeting the sixth learning case. When the second reinforcement learning is repeated, the reinforcement learning part 25 can acquire the second learning result (AI2-2) which has been updated to a more appropriate result. This is similar also in case of repeating the third reinforcement learning.

As described above, when the second and third past learning results have not yet been acquired at the time of the first reinforcement learning, the first learning result can be settled by evaluating, in the evaluation part 26, the result of the first decision making during the first reinforcement learning, and the results of the second decision making and the third decision making based on the second and third rules. Conversely, when the second and third past learning results have already been acquired at the time of the first reinforcement learning, the first learning result can be settled by evaluating, in the evaluation part 26, the result of the first decision making during the first reinforcement learning, and the results of the second decision making and the third decision making based on the second and third past learning results.

When two or more second learning results and/or two or more third learning results were acquired in the past, each of the newest second learning result and the newest third learning result is the learning result to which the highest evaluation is given. Therefore, the first learning result can be settled by evaluating, in the evaluation part 26, the result of the first decision making during the first reinforcement learning, and the results of the second decision making and the third decision making based on the newest second and third learning results. Repeating the first reinforcement learning while updating the second and third learning results allows making the first learning result according to the second and third learning result more appropriate.

This is similar regarding the second reinforcement learning and the third reinforcement learning. Reinforcement learning whose level is not highest, for performing the second decision making or the third decision making, may be started first although FIG. 4 shows the example of case of starting from the first reinforcement learning for performing the first decision making whose level is the highest. When the reinforcement learning for the first decision making is not performed first, the first decision making is performed based on the first rule in the reinforcement learning performed first. As a matter of course, this is similar also in case of performing four or more partial pieces of decision making hierarchically.

Each learning case used for the curriculum reinforcement learning can be prepared by a simulation of a flight of the aircraft 2, as mentioned above. Alternatively, an actual flight case of the aircraft 2 may be used as a learning case. Although it is generally difficult to have the AI before machine learning to perform decision making, an actual flight case of the aircraft 2 can be used as a learning case from the beginning of reinforcement learning in principle since rules have been set in the rule setting part 24 so that a result of the decision making which meets an evaluation criterion may be acquired.

In case of using a simulation as a learning case, a simulator 29 which simulates a position, an altitude, an attitude and the like of the aircraft 2 can be coupled to the I/O interface 20 as exemplified by FIG. 3, and necessary information can be output and input from and to the arithmetic unit 22 of the aircraft control system 1. Information which is output from the AI is results of pieces of decision making, such as a target point, a flight path, and control quantities of the airframe of the aircraft 2. Meanwhile, information which is input into the AI is information, such as the present position, altitude and attitude of the aircraft 2, necessary for the pieces of the decision making.

Accordingly, the AI can determine a target point, a flight path, control quantities of the airframe and the like of the aircraft 2 based on information, specifying a state of the aircraft 2 including the position, altitude and attitude, input from the simulator 29. Then, the simulator 29 can update the information, specifying the state of the aircraft 2 including the position, altitude and attitude, based on the determined control quantities of the airframe of the aircraft 2. After that, the information updated by the simulator 29 can be used as input information into the AI again.

In order to allow the simulator 29 to simulate the state including the position, altitude and attitude of the aircraft 2 with high accuracy, it is desirable to simulate flight environment, such as the atmosphere temperature and wind conditions including a wind direction and a wind speed, in an airspace in which the aircraft 2 is flying.

On the other hand, in case of using an actual flight case of the aircraft 2 as a learning case, the present state including the position, altitude and attitude of the aircraft 2 can be input from the sensors 4 provided in the aircraft 2 into the arithmetic unit 22 of the aircraft control system 1 through the flight controller 3. That is, information, such as the present position, altitude and attitude of the aircraft 2, which should be input into the AI, can be acquired from the sensors 4 provided in the aircraft 2.

Then, control quantities of the airframe of the aircraft 2 which the AI determined based on the present position, altitude, attitude and the like of the aircraft 2 can be output to the flight controller 3. Thereby, the aircraft 2 is controlled, and the state including the position, altitude and attitude of the aircraft 2 changes. After that, the newest state including the position, altitude and attitude of the aircraft 2 can be measured by the sensors 4 provided in the aircraft 2, and used as input information into the AI again.

As described above, the state changing in reinforcement learning whose agent is the AI which controls the aircraft 2 mainly includes the position, altitude and attitude of the aircraft 2 while the action of the AI includes determination of control quantities of the airframe of the aircraft 2, and control of the aircraft 2 by outputting the determined control quantities of the airframe to the simulator 29 or the flight controller 3. The reward to the AI can be set as reward which becomes higher as a distance to a target point becomes shorter, reward which becomes higher as fuel consumption decreases more, reward which becomes higher as the stability of the aircraft 2 is improved more, or the like.

The pilot information generation part 27 has a function to output control information to the flight controller 3 of the aircraft 2, and a function to generate control information which should be output to the flight controller 3. The control information to be output to the flight controller 3 is information, including control quantities of the airframe of the aircraft 2 settled as output information from the AI. More specifically, the control information to be output to the flight controller 3 is information, such as an automatic pilot program, for assisting pilot of the aircraft 2, generated based on input information, including the present position, altitude and attitude of the aircraft 2, into the AI, and rules set in the rule setting part 24 or learning results for objects of pieces of decision making stored in the learning result storing part 28.

Accordingly, in case of using an actual flight case of the aircraft 2 as a learning case of reinforcement learning, control information to be generated in the pilot information generation part 27 is control signals expressing information, which should be output to the flight controller 3, out of final results of pieces of decision making which the reinforcement learning part 25 performed in order to acquire learning results.

Next, a concrete example in case of controlling the aircraft 2 by decisions and reinforcement learning by the AI of the aircraft control system 1 will be described.

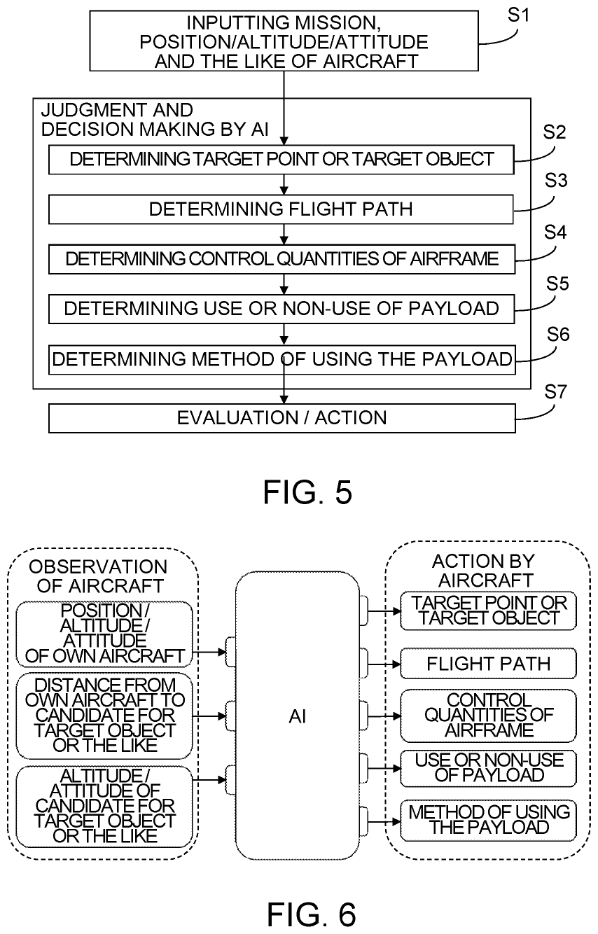

FIG. 5 is a flow chart showing an example of flow in case of controlling the aircraft 2 by the aircraft control system 1 shown in FIG. 3. FIG. 6 shows input information into the AI and output information from the AI for controlling the aircraft 2 shown in FIG. 5.

FIG. 5 shows a flow in a case where input information, including a mission as well as the position, altitude and attitude of the aircraft 2 acquired from the sensors 4 provided in the aircraft 2, is input into the AI in step S1, and subsequently, the reinforcement learning part 25 constituting the AI performs not only determination of a target point or target object of the aircraft 2, determination of a flight path, and determination of control quantities of the airframe, in step S2 to step S4, but determination of whether the payload 11 is used, and determination of how to use the payload 11, in step S5 and step S6.

As explained with referring to FIG. 4, the object of the reinforcement learning performed by the reinforcement learning part 25 is limited to any one of the pieces of the determination. Accordingly, after the pieces of the determination in step S2 to step S6 by the reinforcement learning part 25 are completed, a result of a piece of determination, which is the object of the reinforcement learning, out of the pieces of the determination is evaluated in the evaluation part 26 in step S7, and the pilot information generation part 27 generates control information of the aircraft 2 based on finally settled pieces of the determination. Then, the aircraft 2 can be controlled by outputting the control information from the pilot information generation part 27 to the flight controller 3 of the aircraft 2. That is, the AI can perform action.

When the mission given to the aircraft 2 is detection of a target object, such as another aircraft or a flying object, flying in a specific airspace using the payload 11, such as a camera or a radar, mounted on the aircraft 2, input information and output information to and from the AI are, e.g., information shown in FIG. 6. Specifically, at least the position, altitude and attitude of the aircraft 2 are input into the AI. In addition, a user can give the AI the position of the airspace where the target object is flying, as a piece of input information for specifying the mission of the aircraft 2, until the target object is captured with the radar or camera mounted on the aircraft 2.

Thereby, until the target object is captured with the radar or camera, the airspace where the target object is flying, or a point at which the operating state of the radar or camera should be switched on towards the airspace where the target object is flying can be determined as the target point appropriate in order that the AI may accomplish the mission even when the position and the like of the target object are unknown. Once the target point of the aircraft 2 is determined, it becomes possible to determine a flight path and control quantities of the airframe of the aircraft 2 for moving to the target point based on the present position, altitude and attitude of the aircraft 2.

The flight path of the aircraft 2 can be determined to not only a shortest path or the like but a long detour or the like, according to a valuation method in the evaluation part 26. On the other hand, when the aircraft 2 is a rotorcraft as exemplified by FIG. 1, concrete examples of the control quantities of the airframe of the aircraft 2 include control quantities of the rotating speeds and pitches of the rotors 7. Regardless of whether the aircraft 2 is a rotorcraft or a fixed-wing aircraft, the control quantities of the airframe of the aircraft 2 which the AI determines may include control quantities of parameters, such as a bank angle, thrust and an angular velocity of the aircraft 2, for specifying the attitude of the airframe.

When the aircraft 2 has gone into the target airspace or approached the target airspace, judgment and decision making regarding whether use of the payload 11 is started can be performed. In addition, judgment and decision making regarding a way to use the payload 11 like an orientation of the radar or a direction of the camera can also be performed. Once the target object or a candidate of the target object is observed with the payload 11, such as the radar or camera, the observed data can be input into the aircraft control system 1 through the flight controller 3, and a position, altitude and attitude of the target object or the candidate of the target object observed with the payload 11 can be added to input information into the AI. Thereby, the AI can set a new aim that the aircraft 2 is brought close to the target object or the candidate of the target object to a predetermined distance or that the aircraft 2 is made to follow the target object or the candidate of the target object.

When learning results have been already acquired for all the above-mentioned processes in step S2 to step S6 by pieces of reinforcement learning respectively, the AI can accomplish the mission by pieces of judgment and decision making according to the learning results. That is, the AI can acquire reward through evaluation in the evaluation part 26.

Note that, it is realistic to constitute the AI, which can perform reinforcement learning, with a DNN (deep neural network). A neural network consists of an input layer, at least one hidden layer and an output layer. In many cases, a neural network having two or more hidden layers is defined as a deep neural network. Making a deep neural network perform learning corresponds to optimization of parameters, such as filter coefficients in hidden layers. Therefore, learning results by the AI consist of combinations of values of parameters in a deep neural network.

When any learning result for performing at least one of the pieces of the judgment and decision making has not yet acquired in the AI, it is necessary to perform reinforcement learning to acquire the learning result. Specifically, it is necessary to acquire a combination of values of parameters in a deep neural network through reinforcement learning. As mentioned above, reinforcement learning of the AI is performed in the reinforcement learning part 25, and a learning case for the reinforcement learning may be an actual flight case of the aircraft 2, or may be a simulated flight case. Note that, the processes by the AI shown in FIG. 5 and FIG. 6 are also applied to a case where the AI is made to perform reinforcement learning in a simulation environment.

As explained with referring to FIG. 4, pieces of reinforcement learning are separately performed for pieces of partial decision making respectively. When any past learning result has not yet been acquired regarding a piece of partial decision making, which is not an object of reinforcement learning, the piece of the partial decision making is performed according to one of the rules set in the rule setting part 24 without judgment by the AI, i.e., judgment derived based on a combination of values of parameters in a deep neural network.

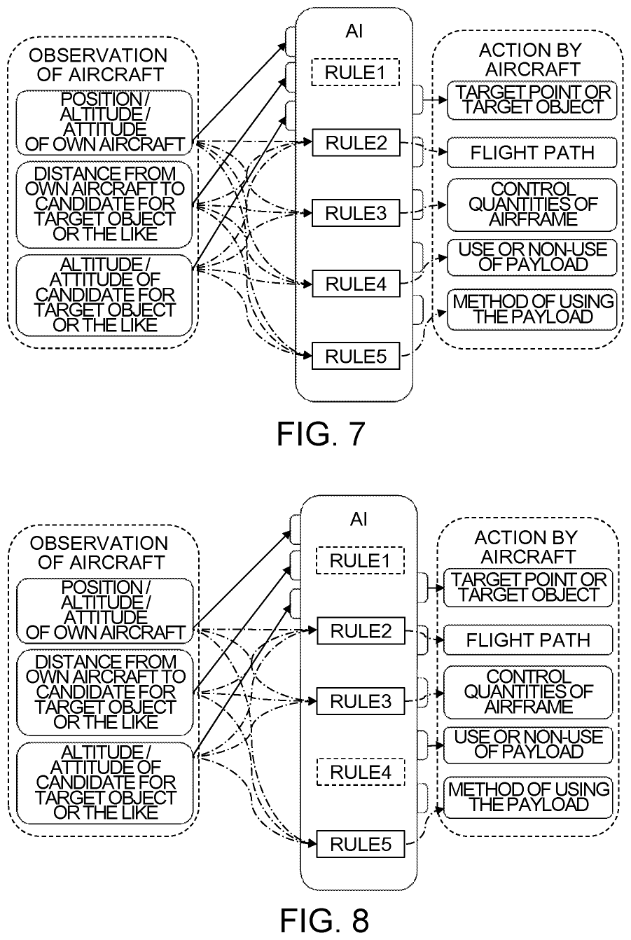

FIG. 7 is a diagram for explaining the learning method of the AI at the time of starting the reinforcement learning shown in FIG. 6. FIG. 8 is a diagram for explaining an example of reinforcement learning of the AI performed subsequently to the reinforcement learning shown in FIG. 7.

As explained with referring to FIG. 4, rules are respectively created for objects of pieces of decision making by the AI in the rule setting part 24. Therefore, when the AI performs pieces of judgment and decision making regarding the five items consisting of the determination of a target point or target object of the aircraft 2, the determination of a flight path, the determination of control quantities of the airframe, the determination of whether the payload 11 is used, and the determination of how to use the payload 11, as shown in FIG. 6, five rules consisting of the first rule to the fifth rule are created in the rule setting part 24. These five rules are determined so that a result of all the pieces of the judgment and decision making may be evaluated to be appropriate in the evaluation part 26 when all the pieces of the judgment and decision making are performed based on only the rules.

At the time of starting the reinforcement learning of the AI, no learning results have been acquired for the pieces of the judgment and decision making. Accordingly, in case of performing the reinforcement learning of the AI with limiting an object to a method of determining a target point or target object of the aircraft 2 whose level is the highest, the AI determines a target point or target object of the aircraft 2 by judgment and decision making based on input information including a position, altitude and attitude of the aircraft 2 without using the first rule for determining a target point or target object of the aircraft 2, and then, the AI outputs the determined result as output information, as shown in FIG. 7.

On the contrary, the four items whose levels are low are respectively determined using the second to fifth corresponding rules whose input values are set to pieces of information including the position, altitude and attitude of the aircraft 2. Each of results, determined based on the second to fifth rules, is certainly estimated to be appropriate in the evaluation part 26. Accordingly, the AI can perform intensive learning regarding a method of determining a target point or target object of the aircraft 2 so that an appropriate result can be output in order to accomplish the given mission.

Once a certain degree of learning result is acquired by the reinforcement learning regarding a method of determining a target point or target object of the aircraft 2, the AI becomes possible to determine an appropriate target point or target object of the aircraft 2 based on the learning result. Accordingly, reinforcement learning of the AI can be started with setting the next desired item to be judged as a learning object.

For example, in case of performing the reinforcement learning of the AI with focusing attention on a method of determining whether the payload 11 should be used, the AI determines whether the payload 11 is used, by judgment and decision making based on input information including a position, altitude and attitude of the aircraft 2 without using any of the fourth rule for determining whether the payload 11 is used, and the first rule for determining a target point or target object of the aircraft 2, for which the learning result has already been acquired, and then, the AI outputs the determined result as output information, as shown in FIG. 8.

On the other hand, a target point or target object of the aircraft 2 is determined by the AI based on the past learning result and the input information including the position, altitude and attitude of the aircraft 2. Namely, although input information including a position, altitude and attitude of the aircraft 2 may change, the AI determines a target point or target object of the aircraft 2 without changing a combination of the newest values of corresponding parameters in the deep neural network for determining a target point or target object of the aircraft 2. In addition, the other three items, for each of which any learning result has not yet been acquired, are respectively determined using the second, third and fifth corresponding rules whose input values are set to information including the position, altitude and attitude of the aircraft 2.

The target point or target object of the aircraft 2 determined based on the past learning result has been already evaluated to be appropriate in the evaluation part 26, and therefore, is evaluated to be appropriate in the evaluation part 26 again. In addition, results determined based on the second, third and fifth rules respectively are certainly evaluated to be appropriate in the evaluation part 26. Accordingly, the AI can perform intensive learning regarding whether the payload 11 is used so that an appropriate result can be output in order to accomplish the given mission.

Thus, curriculum reinforcement learning can be advanced piecemeal by gradually replacing pieces of judgment and decision making according to rules with pieces of judgment and decision making by the AI based on learning results.

As described above, in order to allow the AI to perform a complicated process requiring two or more pieces of decision making, the aircraft control system 1, the method of controlling the aircraft 2, the aircraft control program, and the aircraft 2 perform reinforcement learning of the AI partially with limiting an object to an item of a selected piece of decision making by previously setting rules for performing the pieces of the decision making

### Effect

According to the aircraft control system 1, the method of controlling the aircraft 2, the aircraft control program, and the aircraft 2, it is possible to make the AI perform reinforcement learning of matters required for two or more pieces of decision making for a shorter time in a case where it is necessary to make the AI perform a complicated process requiring the pieces of decision making in order to assist a flight of the aircraft 2.

Specifically, the optimal solution can be searched for a short time since reinforcement learning can be performed in order for each item for which decision making is required although reinforcement learning whose object is all the pieces of decision making requires a great deal of learning time, or may cause acquisition of a local solution that only a result of a part of the pieces of the decision making becomes extremely appropriate.

Moreover, not only a learning time can be reduced, but design of reward can be simplified since an individual learning scale becomes small. Also, as for rules which should be set, it is possible to set simple rules at least allowing the AI to accomplish a mission since each rule is replaced with a learning result as the learning of the AI progresses. As a result, the development scale of the AI can be reduced.

In addition, whether the learning method by reinforcement learning is appropriate can be easily judged for each item of decision making, and the optimal judgment by the AI can be adopted for each item of decision making. Accordingly, automatic pilot of the aircraft 2 can be made more suitable.

### Other Implementations

While certain implementations have been described, these implementations have been presented by way of example only, and are not intended to limit the scope of the invention. Indeed, the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. An aircraft control system comprising:
circuitry configured to:
set a rule, first decision making being performed prior to second decision making, the first decision making and the second decision making being performed for flying an aircraft, the rule being used for performing the second decision making based on an initial result of the first decision making;
acquire a first learning result and a second learning result, the first learning result being acquired by first reinforcement learning targeting a first learning case, the second learning result being acquired by second reinforcement learning targeting a second learning case different from the first learning case, the first learning result being used for the first decision making, the second learning result being used for the second decision making;
evaluate results of the first decision making and results of the second decision making; and
generate information for supporting pilot of the aircraft, based on the first learning result and the second learning result,
wherein the circuitry is configured to:
settle the first learning result by evaluating the initial result of the first decision making through the first reinforcement learning and a result of the second decision making based on the rule when the second learning result has not been acquired prior to the first reinforcement learning, and
settle the first learning result by evaluating another result of the first decision making through the first reinforcement learning and another result of the second decision making based on the second learning result when the second learning result has been acquired prior to the first reinforcement learning.

2. The aircraft control system according to claim 1,
wherein the first decision making includes determining a target point of the aircraft while the second decision making includes determining a flight path of the aircraft to the target point.

3. An aircraft comprising the aircraft control system according to claim 1.

4. A method of controlling an aircraft comprising:
setting a rule, first decision making being performed prior to second decision making, the first decision making and the second decision making being performed for flying the aircraft, the rule being used for performing the second decision making based on an initial result of the first decision making;
acquiring a first learning result and a second learning result, the first learning result being acquired by first reinforcement learning targeting a first learning case, the second learning result being acquired by second reinforcement learning targeting a second learning case different from the first learning case, the first learning result being used for the first decision making, the second learning result being used for the second decision making;
evaluating results of the first decision making and results of the second decision making; and
generating information for supporting pilot of the aircraft, based on the first learning result and the second learning result,
wherein the first learning result is settled by evaluating the initial result of the first decision making through the first reinforcement learning and a result of the second decision making based on the rule when the second learning result has not been acquired prior to the first reinforcement learning, and
the first learning result is settled by evaluating another result of the first decision making through the first reinforcement learning and another result of the second decision making based on the second learning result when the second learning result has been acquired prior to the first reinforcement learning.

5. A recording medium with an aircraft control program making a computer execute:
setting a rule, first decision making being performed prior to second decision making, the first decision making and the second decision making being performed for flying an aircraft, the rule being used for performing the second decision making based on an initial result of the first decision making;
acquiring a first learning result and a second learning result, the first learning result being acquired by first reinforcement learning targeting a first learning case, the second learning result being acquired by second reinforcement learning targeting a second learning case different from the first learning case, the first learning result being used for the first decision making, the second learning result being used for the second decision making;
evaluating results of the first decision making and results of the second decision making; and
generating information for supporting pilot of the aircraft, based on the first learning result and the second learning result,
wherein the first learning result is settled by evaluating the initial result of the first decision making through the first reinforcement learning and a result of the second decision making based on the rule when the second learning result has not been acquired prior to the first reinforcement learning, and
the first learning result is settled by evaluating another result of the first decision making through the first reinforcement learning and another result of the second decision making based on the second learning result when the second learning result has been acquired prior to the first reinforcement learning.

6. The method according to claim 4,
wherein the first decision making includes determining a target point of the aircraft while the second decision making includes determining a flight path of the aircraft to the target point.

7. The recording medium according to claim 5,
wherein the first decision making includes determining a target point of the aircraft while the second decision making includes determining a flight path of the aircraft to the target point.

8. An aircraft comprising the aircraft control system according to claim 2.
